(19) United States
(12) Patent Application Publication
(10) Pub. No.: US 2017/0310139 A1
(43) Pub. Date: Oct. 26, 2017

(54) Integrated Lighting System

(71) Applicant: Exhart Environmental Systems, Inc., Chatsworth, CA (US)

(72) Inventors: Michael Weiser, Calabasas, CA (US); Margaret Weiser, Tarzana, CA (US)

(73) Assignee: Exhart Environmental Systems, Inc.

(21) Appl. No.: 15/487,204

(22) Filed: Apr. 13, 2017

Related U.S. Application Data
(60) Provisional application No. 62/326,493, filed on Apr. 22, 2016.

(51) Int. Cl. H02J 7/00; H05B 37/02; H02J 7/35; G09F 13/04

(52) U.S. Cl. CPC H02J 7/0068; H05B 37/0281; H05B 37/0218; H02J 7/355; H02J 7/0029; H02J 7/0077; G09F 13/0413; G09F 2013/0463; H02J 2007/0037; H02J 2007/0039

(57) ABSTRACT

An integrated lighting system to efficiently manage battery life with indoor and outdoor modes by charging a battery during the day, turning on lights at peak night hours, and protecting the battery from overvoltage/leakage. The system comprises circuitry operable to connect to the battery and the LED light sources, the circuitry comprising a solar cell, a timer circuit, and a protection circuit. The solar cell charges the battery during daylight hours. The timer circuit regulates time periods during the day to turn on the LED light source. The overcharge circuit prevents damage from possible overcharge/leakage.

### CROSS REFERENCE TO RELATED APPLICATION

This patent application claims priority to provisional U.S. Patent Application Ser. No. 62/326,493 filed Apr. 22, 2016, which application is incorporated in its entirety here by this reference.

### TECHNICAL FIELD

This invention relates to lighting systems integrated in products for indoor and outdoor use. In particular, the invention relates to a system and method for selectively powering lights sources and charging a battery safely.

### BACKGROUND

Lighting systems are necessary to make signs and decorations visible at night or in the dark. For products that do not have an easily accessible power outlet or that are meant to be moved around, batteries are commonly employed to power the lights. A system using batteries must regulate the power consumption to maximize the battery life. In lighting systems, the system should attempt to maximize the duration and intensity of the lighting display during peak display hours and charge the battery or minimize battery usage during other hours. In the case of a consumer product with battery charging capability, additional safeguards must be put in place to prevent damage to the system that may occur when using non-rechargeable batteries. For the foregoing reasons, there is a need for a smart lighting system that maximizes battery life and provides protection in the use of different battery types.

### SUMMARY

The invention features a novel lighting system and method. The lighting system in the preferred embodiment includes one or more light sources; a battery receptacle configured to receive a battery; a solar cell; a switch including an outdoor mode and indoor mode; a timing circuit; and a controller. The controller is configured to: automatically power on and power off the one or more light sources based on an ambient light level detected by the solar cell if the switch is set to the outdoor mode; automatically power on and power off the one or more light sources based on the timing circuit if the switch is set to the indoor mode; detect the type of battery in the receptacle; and automatically determine whether or not to charge the battery in the receptacle with power from the solar cell based on the type of battery. In some embodiments, the controller is further configured to determine whether the battery has reached charge capacity and to automatically stop charging the battery in the receptacle if the battery has reached charge capacity.

A method of operating a lighting system in the preferred embodiment comprises receiving a user setting selected from the group consisting of outdoor mode, indoor mode, and off. If the outdoor mode is selected by the user, then the controller: determines an ambient light level; energizes one or more light sources with a battery if the ambient light level is below a predetermined threshold; and charges the battery with the one or more light sources off if the ambient light level is above the predetermined threshold. If the indoor mode is selected, then the controller is configured to: determine the time of day; energize the one or more light sources with a battery if the time of day is nighttime; and charge the battery with the one or more light sources off if the time of day is daytime. The method may further include the steps of determining whether the battery has reached charge capacity and automatically terminating the charging of the battery if the battery has reached charge capacity.

### BRIEF DESCRIPTION OF DRAWINGS

FIG. 1 shows a first sample embodiment of an integrated lighting system in accordance with an embodiment of the present disclosure;

FIG. 2 shows a second sample embodiment of an integrated lighting system in accordance with an embodiment of the present disclosure;

FIG. 3 shows a functional block diagram of an integrated lighting system in accordance with an embodiment of the present disclosure; and

FIG. 4 shows a flowchart of the operational modes of the integrated lighting system in accordance with an embodiment of the present disclosure;

FIG. 5 shows a circuit diagram in accordance with an embodiment of the present disclosure.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

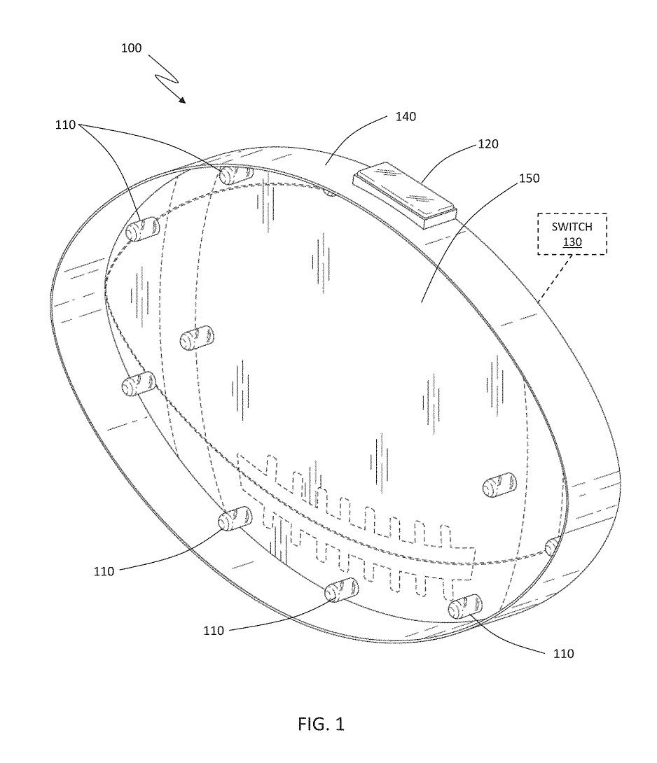

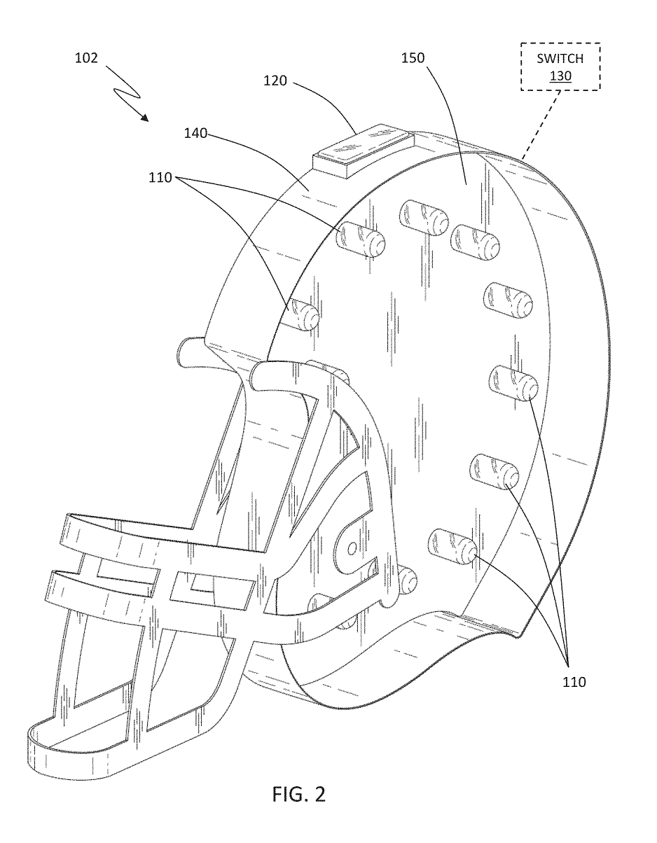

FIGS. 1 and 2 show example integrated lighting systems that utilize the present invention. FIG. 1 depicts a portable lighting system 100 with a football design and FIG. 2 depicts a portable lighting system 102 with a football helmet design. These portable lighting systems may be operated both indoors and outdoors to provide light as need while exhibiting support for a sport and/or a particular team. In other embodiments, the lighting systems may be designed to resemble garden lights, party lights, wall art, people, animals, plants and vegetables, sculptures, figurines, characters, cartoon figures, geometric shapes including stars and arrows, and any of various utilitarian objects with, for example, residential or nautical themes.

As shown, the portable lighting systems 100, 102 comprise a plurality of light sources 110, one or more photovoltaic cells referred to herein as a solar cell 120, a switch 130 enabling the user to select one of a plurality of operation modes, a frame 140, and backing 150 to which the light sources are mounted. In the preferred embodiment, the plurality of light sources include a plurality of light emitting diodes (LED) configured to radiate light from the portable light system and, in some embodiments, light up the frame 140 and backing 150. In the football design in the first embodiment 100, for example, the frame 140 has the shape of a football and the backing 150 includes graphical indicia with the color and texture of a football as well as a team name and/or logo. The frame 140 also extends forward out beyond the surface of the backing 150. When the LED lights 110 are energized, the LED lights illuminate (a) the inner side of the frame to accentuate the outline of the football as well as (b) the name of the team and color/texture of the football. These two lighting effects, in combination, provide a visually pleasing aesthetic for football fans affiliate with the designated team.

The second embodiment 102 of the portable lighting system includes a frame 140 in the shape of a football helmet and a backing 150 graphically depicting the color and texture of a helmet complete with team name and/or logo. Similar to the first embodiment 100, the frame 140 in the second embodiment 102 extends beyond the backing 150 so that the inner side of the frame may be illuminated by light from the LED lights 110. Thus, the illumination of the outline of the helmet together with the illumination of the logo provides a visually pleasing aesthetic for football fans affiliate with the designated team.

The portable lighting systems 100, 102 also include a solar cell 120 placed at the top of the frame 140 in a position to receive light from the sun or other external light source. In some embodiments, the solar cell is removably attached to the portable lighting system to enable the user to aim the solar cell at the sun independent of the orientation of the frame 140 and backing 150. In some other embodiments, the solar cell 120 may be attached to an extendable arm and/or rotatable arm to vary the position and/or orientation of the solar cell, thus allowing for the optimal capture of light.

In some embodiments, the solar cell 120 includes a hook and loop fastener to detachably attach the solar cell to various surfaces to improve the capture of light. In some embodiments, the solar cell may be set up a distance away from the frame 140 and backing 150 so that the solar cell may be placed in sunlight while the frame and backing are in the shade, which would give a user snore flexibility in placing the portable display indoors or outdoors. In these embodiments, the solar cell 120 is connected to the frame 140 or backing 150 using a wire to deliver current to a battery that is protectively concealed behind the backing.

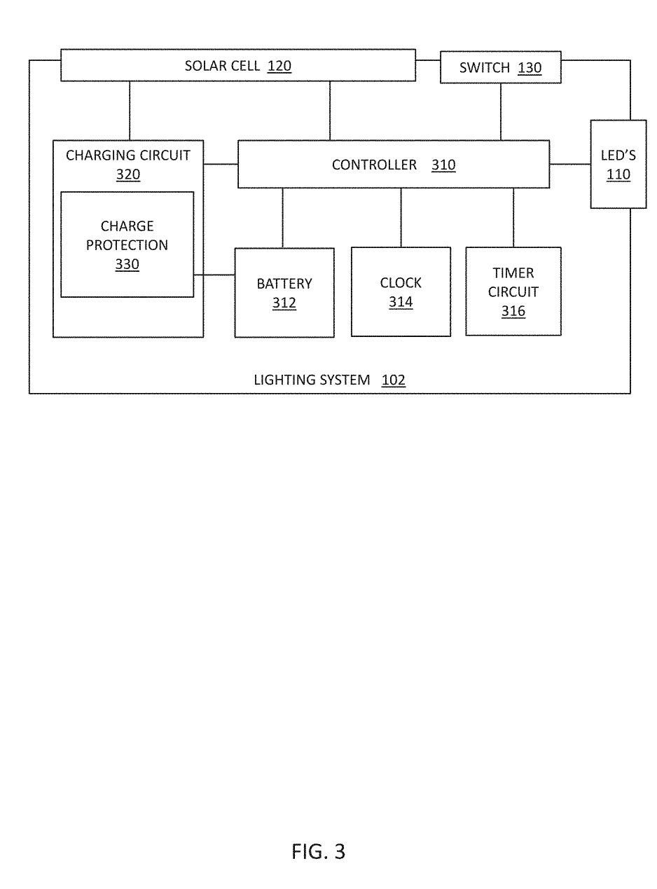

Illustrated in FIG. 3 is a functional block diagram of the portable lighting system 102. The lighting system 102 includes a controller 310 that is operatively connected to the solar cell 120, the switch 130, and LED lights 110 visible from the exterior of the lighting system. In addition, the controller 310 is operatively connected to a charging circuit 320 with a charge protection circuit 330, a receptacle 312 for a replaceable battery, a clock 314 and/or a tinning circuit 316.

The integrated lighting system of the present invention s intended to be used both indoors and outdoors. In response to the switch 130 setting selected by a user, the controller generally assumes one of three selectable modes: outdoor mode, indoor mode, and off. In the outdoor mode, the controller 310 determines the ambient light level and turns the LED lights 110 on and off automatically. In particular, the controller 310 energizes the LED lights 110 at night and generally charges the battery during the day. In the indoor mode, the controller 310 turns the LEDs on and off automatically based on the time of day as determined by a clock circuit 314 or based on the time as measured by a timing circuit 316. The controller 310 and other circuitry may be protectively concealed by a water-tight housing to prevent damage from precipitation, wind, as well as dust and other airborne debris.

In both the outdoor and indoor modes, the controller 310 includes a charging circuit 320 configured to determine if and when to charge the battery based on the amount of light acquired by the solar cell 120 as well as the type of battery employed. In particular, a charging circuit 330 detects the type of battery being used and (a) enables proper charging of the battery if a rechargeable battery is used, or (b) prevents any charging of the battery if a non-rechargeable battery is used. Any attempt to charge a non-rechargeable battery poses a fire and safety risk if, for example, a regular alkaline battery is installed by the user. The protection circuit 330 in the preferred embodiment may comprise comparators, inductors, capacitors, and other such components to detect overvoltage, overcurrent, or other conditions that drawn power away from the battery to prevent possible battery overcharge.

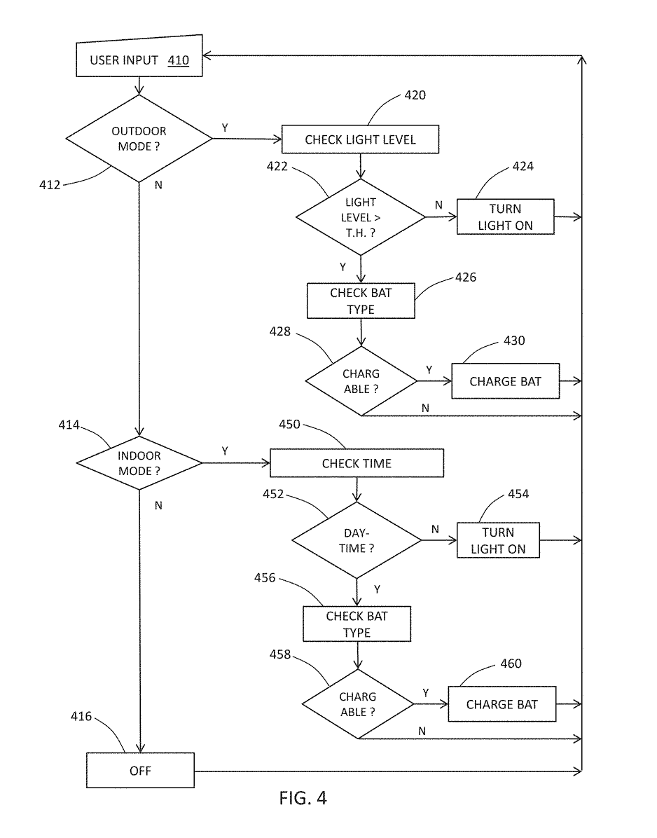

Illustrated in FIG. 4 is a flowchart of the operational modes of the integrated lighting system in accordance with an embodiment of the present disclosure. The user manually selects 410 the operational state of the lighting system using the switch 130. If the user selects the outdoor mode, decision block 412 is answered in the affirmative and the controller determines 420 the ambient light level using the solar cell 120 as a sensor. If the ambient light level below a predetermined threshold, decision block 422 is answered in e negative and the LED lights are energized 424 using power from the battery in the receptacle 312. If the ambient light level is above the predetermined threshold, decision block 422 is answered in the affirmative the charging circuit activated. The charging circuit 320 determines 426 the battery type to start. If the replaceable battery is a rechargeable battery and not fully charged, decision block 428 is answered in the affirmative and the battery charged until the user changes the switch setting, the ambient light level drops below threshold, or the battery fully charges.

If the user manually selects the indoor mode of operation, the controller 310 checks 450 the time as measured by a clock 314 or a timing circuit 316. If it is determined to be nighttime, decision block 452 is answered in the negative and the LEI) lights 110 energized 454. If it is determined to be daytime, however,decision block 452 is answered in the affirmative and the charging circuit activated. As described above, the charging circuit 320 determines 456 the battery type to start. If the replaceable battery is a rechargeable battery and not fully charged, decision block 458 is answered in the affirmative and the battery charged until the user changes the switch setting, daytime arrives, or the battery fully charges.

When not in the outdoor mode or indoor mode, the switch may be set to the off position 416 in which the LED lights are off and the battery not charged.

In some embodiments, the timer circuit 316 is used to determine when to power the LED lights. The timer circuit may, for example, be set on a 24 hour cycle to turn the LED lights on at night for a four hour period from 5 p.m. to 9 p.m. This would prevent unnecessary illumination during the day which would have little effect and would drain the battery. In some embodiments, an interface is configured to allow the user to select operating time periods for the LED lights. In some embodiments, a clock circuit is employed to automatically turn the system on and off at the same times every day.

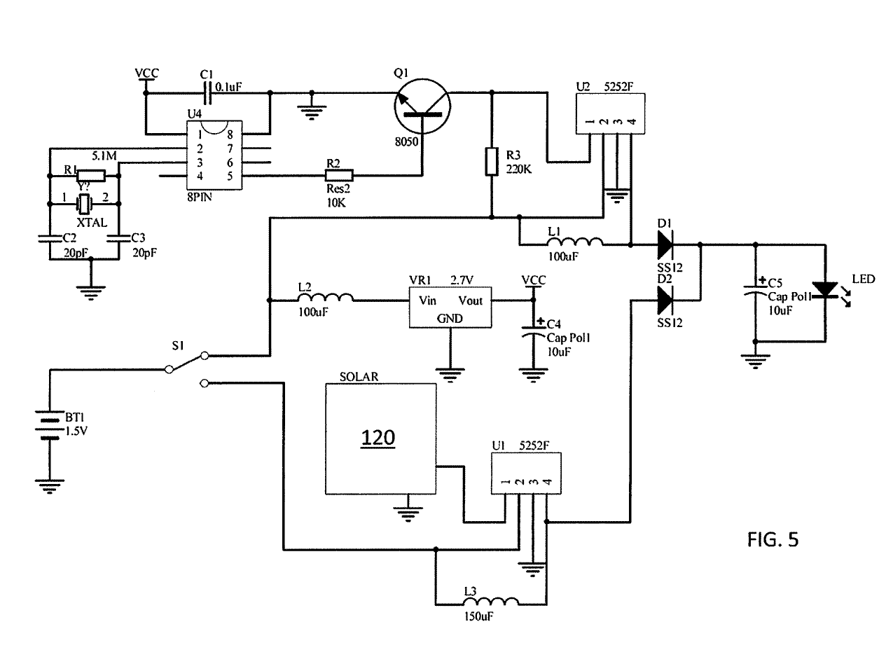

FIG. 5 depicts a circuit diagram of an embodiment of the present invention. The circuit diagram comprises a first circuit portion for implementing the outdoor mode and a second circuit portion for implementing the indoor mode. The first circuit portion generally comprises a solar LEI) lighting controller U1, an inductor L3, diodes D1 and D2, a capacitor C5, and the solar cell 120. The controller U1 is preferably a model QX5252F controller supplied by Multicomp. The lighting controller U1 works with the solar cell 120 to power the LED lights 110. It has an internal switching circuit and over discharge protection circuit. The inductor L3 is a 150 uF inductor connected across pins 2 and 4 of the controller U1 to regulate the output current that goes to the LED lights 110. The diodes D1 and D2 (collectively referred to as SS12) form a Schottky Barrier Rectifier that permits current to flow from the controller U1 to the LED lights 110. The capacitor C5 is 10 uF capacitor configured to filter out noise and smooth out the current supplied to the LED lights 110. Together, the components of the first circuit portion are configured to charge the battery when there is current coming from the solar panel and drive the LED lights 110 using power from the battery BT1 (mounted in receptacle 312) at night.

The second circuit portion generally comprises a boost converter comprising inductor L2 and diode VR1, a filter capacitor C4, a microcontroller U4, a resistor R1, a crystal oscillator XTAL, capacitors C2, C3, an NPN transistor Q1 model QX5252F controller U2, and an inductor L1. The boost converter, including a 100 uF inductor and diode VR1, is configured to convert the 1.5 volts from the battery BT1 to 33 volts. The filter capacitor C4 is a 10 uF capacitor configured to filter and regulate the 3.3 v power supply. The microcontroller U4 is configured to produce a control signal for turning the LED lights 110 ON and OFF at predefined intervals of time. The resistor R1 is a 5M Ω resistor. The crystal oscillator XTAL is configured to generate the desired clock for the microcontroller U4. The capacitors C2, C3 are 20 pF capacitors configured, along with the crystal oscillator XTAL, to generate fixed clock cycles. The NPN transistor Q1 is configured to act as a switch between the supplied power from Vcc and pin 1 of a second controller U2. The base terminal of NPN transistor Q1 goes through a 10 k Ω resistor to pin 5 of microcontroller U4 which gives the control signal for the LED lights 110. The second controller U2, another model QX5252F controller, is configured to save power by compensating for the internal built-in LED driver circuit, which produces fast switching in the output. Without the second controller U2, the LED lights 110 would continuously switch between the ON and OFF states so fast that it would be unnoticeable to the human eye. The inductor L1 is configured to regulate the output power from the second controller U2.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A portable lighting system comprising:
one or more light sources;
a battery receptacle configured to receive a battery;
a solar cell;
a switch including an outdoor mode and indoor mode;
a timing circuit; and
a controller configured to:
i. automatically power on and power off the one or more light sources based on an ambient light level detected by the solar cell if the switch is set to the outdoor mode;
ii. automatically power on and power off the one or more light sources based on the timing circuit if the switch is set to the indoor mode;
iii. detect a type of battery in the battery receptacle; and
iv. automatically determine whether or not to charge the battery in the battery receptacle with power from the solar cell based on the type of battery detected.

2. The portable lighting system in claim 1, wherein the controller is further configured to:
determine whether the battery has reached charge capacity; and
automatically stop charging the battery in the receptacle if the battery has reached charge capacity.

3. The portable lighting system in claim 2, wherein the timing circuit comprises a clock.

4. The portable lighting system in claim 2, wherein the timing circuit comprises a timer circuit.

5. The portable lighting system in claim 2, further comprising a frame and a backing wherein the one or more light sources are mounted to the backing and configured to illuminate the backing and an inner surface of the frame.

6. The portable lighting system in claim 5, wherein the frame comprises a football design or football helmet design, and the backing comprises a football team name or logo.

7. A method of operating a lighting system, the method comprising:
receiving a user setting selected from the group consisting of outdoor mode, indoor mode, and off;
if the outdoor mode is selected, then:
i. determining an ambient light level;
ii. energizing one or more light sources with a battery if the ambient light level is below a predetermined threshold; and
ii. charging the battery with the one or more light sources off if the ambient light level is above the predetermined threshold; and
if the indoor mode is selected, then:
i. determining a time of day;
ii. energizing the one or more light sources with a battery if the time of day is nighttime; and
iii. charging the battery with the one or more light sources off if the time of day is daytime.

8. The method of claim 7, further comprising:
determining whether the battery has reached charge capacity; and
automatically terminating charging of the battery if the battery has reached charge capacity.

9. The method of claim 8, wherein determining a time of day comprises:
determining the time of day with a timing circuit comprising a clock.

10. The method of claim 8, wherein determining a time of day comprises:
determining the time of day with a timing circuit comprising a timer.

11. The method of claim 8, wherein the lighting system comprises a frame and a backing, wherein the one or more light sources are mounted to the backing and configured to illuminate the backing and an inner surface of the frame.

12. The method of claim 11, wherein the frame comprises a football design or football helmet design, and the backing comprises a football team name or logo.
